(19) United States
(12) Patent Application Publication
(10) Pub. No.: US 2024/0391830 A1
(43) Pub. Date: Nov. 28, 2024

(54) METHOD FOR RECYCLING CONCRETE MATERIALS TO PRODUCE RECLAIMED CONCRETE AGGREGATE MATERIAL FOR USE IN CONCRETE-BASED MATERIALS AND STRUCTURES

(71) Applicant: Rowan University, Glassboro, NJ (US)

(72) Inventors: Shahriar Abubakri, Glassboro, NJ (US); Gilson R. Lomboy, Williamstown, NJ (US); Joshua Jacob Pizzillo, Mt. Ephraim, NJ (US)

(21) Appl. No.: 18/672,172

(22) Filed: May 23, 2024

Related U.S. Application Data
(60) Provisional application No. 63/468,421, filed on May 23, 2023.

(51) Int. Cl. C04B 18/167; C04B 20/02

(52) U.S. Cl. CPC C04B 18/167; C04B 20/026

(57) ABSTRACT

An environmentally-friendly approach to producing concrete using reclaimed concrete aggregate material is provided. Reclaimed concrete aggregate material is obtained by processing recycled concrete aggregate (RCA) waste materials with an impact treatment. The RCA contains natural stone or other aggregate particles that has cementitious material bonded thereto. The impact treatment removes at least a portion of the cementitious material from the aggregate particles, leaving reclaimed concrete aggregate particles having sufficiently little bonded cementitious material so as to be a suitable alternative to virgin aggregate in asphalt and concrete mixes, even for concrete that will be used in structural load-bearing applications for use to construct structural members of buildings and other structures. The impact treatment may be performed by tumbling RCA with impactors in a rotating drum.

### CROSS-REFERENCE TO RELATED APPLICATIONS

This application claims the benefit of priority, under 35 U.S.C. § 119 (e), of U.S. Provisional Patent Application No. 63/468,421, filed May 23, 2023, the entire disclosure of which is hereby incorporated herein by reference.

### FIELD OF THE INVENTION

The present invention relates generally to concrete which typically contains natural stone “aggregate” materials, and more particularly, to a method for recycling concrete to obtain recycled concrete aggregate material, and a further recycling method that involves processing such recycled concrete aggregate (RCA) material to make a reclaimed concrete aggregate material suitable for use in partial- or full-substitution for natural aggregate to make new concrete material and new concrete structures.

### DISCUSSION OF RELATED ART

Concrete is typically made by mixing portland cement in dry powder form (e.g., 10-15%) with water (e.g., 15-20%) make a paste. This hydrated cement paste is then mixed with aggregate material (e.g., 65-75%) such as sand and gravel, or crushed stone. As the cement and water mix, they harden and bind the aggregates into a hardened concrete mass.

Concrete materials and structures are often demolished, either intentionally or by hazards such as earthquakes, explosions or for various other reasons, and often end up in landfills. Demolished concrete structures are often replaced with new concrete structures. Even in instances in which new structures are not replacing old structures, demand for concrete building materials is expected to continue.

It is generally known in the industry that demolished concrete material may be recycled by crushing it, to form what is generally called Recycled Concrete Aggregate (“RCA”). Depending upon the original concrete structure that is crushed, the RCA may contain bricks, tiles, metals, and other mixed materials such as glass, wood, paper, plastic, and debris along with the crushed concrete. It is also known in the art that RCA may be incorporated into new concrete. However, the variability of materials (and hence, material properties) of the RCA makes the use of new concrete including RCA unsuitable for many applications, such as applications involve use in structures in which predictable and consistent concrete material properties and high strengths are required.

Further, conventional methods of recycling concrete to produce RCA involve crushing and sieving crushed concrete. More particularly, conventional concrete recycling methods involve crushing old concrete structures, obtaining relatively small-size aggregates/chunks and then sieving them to a desired gradation based on particle/chunk size alone.

Even when RCA does not include materials other than crushed concrete, the graded RCA material is made up of particles/chunks that include not only natural stone/aggregate but also attached cement and/or mortar, as a result of the composition of the demolished concrete waste and the crushing process. The attached paste and/or mortar significantly affects the structural characteristics or other performance of new concrete including such conventional RCA, because the paste and/or mortar portions have material properties that are weaker than the stone or other virgin aggregate portions.

By way of further example, new concrete containing conventional RCA presents significant mechanical and durability property concerns. For example, the attached paste and/or mortar increases water absorption, increases Los Angeles (L.A.) abrasion loss, and reduces the density of the conventional RCA. The increased water absorption also adversely affects the workability of new concrete containing conventional RCA. Concrete made with conventional RCA has been found to typically show a reduction in compressive strength by up to 30% as compared with new concrete made with natural/virgin aggregate.

One of the biggest challenges in producing RCA is to effectively remove attached paste and/or mortar from the surface of the stone/coarse aggregate portions of the RCA. Conventional approaches for doing so, to improve the overall quality of the RCA material, involve carbonation, heating, and mechanical grinding are used to improve the quality of the RCA. These methods are typically difficult to employ and often not practical for recycled production plants. Further, these methods may result in further carbon dioxide production, which contributes further to the carbon dioxide production already associated with concrete production, which is undesirable, and they are expensive and otherwise not practical. By way of further example, acid treatment can remove the adhered cement/mortar but it's not feasible for RCA production plants to use it (due to safety and financial concerns).

Therefore, using RCA materials (that is a combination of stone and weaker mortar) in new concrete as aggregate in substitution for stone alone results in weaker concrete due to the inclusion of the weaker cement and/or mortar portions, which is undesirable, and unsuitable for use in many structural/building applications. Accordingly, the included cement and/or mortar presents significant obstacles to the use of conventional RCA in new concrete for structural applications. This adverse effect on the mechanical and durability properties of new concrete limits the use of conventional RCA for new concrete, and therefore, concrete including conventional RCA is typically used only for nonstructural applications.

What is needed is a method for recycling concrete, and more particularly for producing improved RCA suitable for use to create new concrete suitable for use in structural/building applications that is practical and that does not require significant carbon dioxide production and emissions.

### SUMMARY

The present invention relates generally to recycling concrete materials to obtain recycled concrete aggregate RCA material, and further to processing such RCA material to produce a reclaimed concrete aggregate material suitable for use in partial- or full-substitution for natural aggregate to make new concrete material and new concrete structures.

More particularly, the present invention provides for processing of conventional RCA material by impact treatment to reduce the amount of mortar attached to the stone/natural/other aggregate, to provide reclaimed concrete aggregate material having improved material properties relative to conventional RCA, and thus to improve the material properties and/or characteristics (e.g., mechanical properties and durability) of new concrete including reclaimed concrete aggregate relative to new concrete including conventional RCA. The reclaimed concrete aggregate material may alternatively be used to produce new concrete asphalt.

Accordingly, the present invention provides a method for improving the quality of the recycled concrete aggregates for use in concrete-based materials and structures, and can be used to produce reclaimed concrete aggregate material that has material properties/characteristics superior to those of conventional RCA, and such reclaimed concrete aggregate material may be used to produce new concrete suitable for use in structural/building applications in a manner that is practical and that does not require significant additional carbon dioxide production and emissions.

### BRIEF DESCRIPTION OF THE FIGURES

An understanding of the following description will be facilitated by reference to the attached drawings, in which:

FIG. 1 is a flow diagram illustrating a method for recycling concrete waste to produce reclaimed concrete aggregate and structures formed of new concrete comprising reclaimed concrete aggregate in accordance with an exemplary embodiment of the present invention;

FIG. 2 is a process diagram illustrating an exemplary method for producing reclaimed concrete aggregate of FIG. 1;

FIG. 3 shows obtained recycled concrete aggregate (RCA) concrete waste materials in random sizes, ready for impact treatment in accordance with the present invention;

FIG. 4 shows the obtained recycled concrete aggregate (RCA) material of FIG. 3 in a drum of an LA abrasion machine;

FIG. 5 shows the obtained RCA material of FIG. 3 and heavy steel impactors in a drum of the LA abrasion machine ready for crushing impact treatment by tumbling, in accordance with an exemplary embodiment of the present invention;

FIG. 6 shows crushed RCA materials, along with the heavy steel balls, as crushed after the crushing impact treatment;

FIG. 7 shows the reclaimed concrete aggregate material, after sorting/sieving to separate the reclaimed concrete aggregate material from cementitious material removed by the crushing impact treatment;

FIG. 8 shows a table showing bulk specific gravity (both dry and saturated surface dry), apparent specific gravity, and absorption of a control (conventional untreated RCA) and reclaimed concrete aggregate (conventional RCA after impact treatment in accordance with the present invention), for RCA generated by crushing concrete mixes prepared with water-cement ratios of 0.48 and 0.38, respectively, exhibiting different compressive strengths; and

FIG. 9 is a graph comparing compressive strengths of exemplary concrete specimens including conventional RCA (control) and reclaimed concrete aggregate ((conventional RCA after impact treatment in accordance with the present invention), after 7, 28 and 90 days of curing, respectively, showing that the impact treatment improved the strength of the concrete.

### DETAILED DESCRIPTION

Existing concrete recycling plants generally use mechanically-drive jaws to crush concrete blocks. This simply crushes the concrete and has no effect on separating aggregate from attached (cemented) paste. However, aggregates collected after such crushing may be further improved for use as RCA, e.g., by separating the paste from the concrete aggregate.

The present invention provides a method for recycling concrete that includes crushing waste/demolished/old concrete material to obtain generally conventional RCA material, and then further processing the RCA material with an impact treatment to produce a reclaimed concrete aggregate material suitable for use in partial- or full-substitution for natural/virgin aggregate to make new concrete material and new concrete structures suitable for use in structural/building applications and/or asphalt.

The impact treatment removes a significant part of the adhered cement/mortar attached to conventional RCA by way of mechanical impact. For example, conventional RCA may be processed in accordance with the present invention to remove a significant part of the adhered cement/mortar by tumbling the conventional RCA in a drum with heavy steel balls (e.g., 500 cycles of tumbling) to crush the cement/mortar, remove sharp edges of the mortar, etc. to provide mechanical-impact-processed RCA (referred to herein as “reclaimed concrete aggregate”) that contains less adhered mortar than the original/conventional RCA. RCA manufacturing plants can implement this method along with their conventional crushing and sieving methods to provide reclaimed concrete aggregate having improved mechanical and other properties/characteristics relative to conventional RCA.

The reclaimed concrete aggregate may then be used as a substitution for aggregate or conventional RCA in the formation of new concrete. The processing/mechanical impacting/tumbling reduces the quantity of old relatively weak cement/mortar on the conventional RCA and thus new concrete including reclaimed concrete aggregate includes less old concrete/mortar than conventional RCA, and thus new concrete including reclaimed concrete aggregate instead of conventional RCA provides an increase in overall structural properties of new concrete including such reclaimed concrete aggregate relative to use of conventional RCA. Further, such processing also removes cement/mortar to provide greater surface area on the stone/aggregate chunks for new mortar-to-stone bonding area, and thus provide for better/stronger interfacial transition zone bonding, and thus increases the overall structural properties of new concrete including such reclaimed concrete aggregate, relative to new concrete containing conventional RCA.

The quality of conventional RCA can be improved by a mechanical impact process in accordance with the present invention to improve the quality of new concrete including reclaimed concrete aggregate by about 25% relative to concrete made with conventional RCA.

The impact can also involve various types or degrees of abrasion/grinding as a results of the impact treatment. In addition, the duration of grinding and the degree of intensiveness may be different for different types of aggregates. Furthermore, other admixtures or modifications may be needed to the final treated aggregate such as washings, the addition of filler (e.g., nanoparticles), gradation, solutions, etc. By way of example, chemical solutions or fillers can be used to fill in the pores of the RCA particles, if desired.

Accordingly, the present invention can be used to produce reclaimed concrete aggregate material that has material properties/characteristics superior to those of conventional RCA, and such reclaimed concrete aggregate material may be used to produce new concrete suitable for use in structural/building applications in a manner that is practical and that does not require significant additional carbon dioxide production and emissions.

In accordance with the present invention, the method comprises obtaining conventional recycled concrete aggregate (RCA) waste materials (crushing concrete waste materials to obtain conventional RCA if necessary) containing stone aggregate having adhered cement and/or mortar, and then processing the RCA to remove at least a portion of the adhered cement and/or mortar to provide reclaimed concrete aggregate having less adhered cement and/or mortar than the starting materials/conventional RCA material.

Generally, conventional RCA is crushed and sieved to sort particles/chunks into sizes ranging from about 3.5 inches to about 0.2 inches as known in the art. The present invention involves processing the conventional RCA by mechanical impacting (e.g., tumbling with heavy steel balls in a drum) to remove at least about 95% and more of the adhered paste and mortar present in the starting materials.

By way of example, the processing may involve one or more mechanical impacting steps, each mechanical impacting step may involve one or more tumbling, sieving (removing fine particles) or other impact-based steps, such as scrubbing. By way of example, a crushing step involving tumbling of conventional RCA materials in a drum along with heavy steel balls heavy and hard enough to crush the RCA materials during tumbling in the drum (in a manner somewhat similar to a conventional Los Angeles (LA) testing process) to remove adhered cement and/or mortar may be suitable for this purpose.

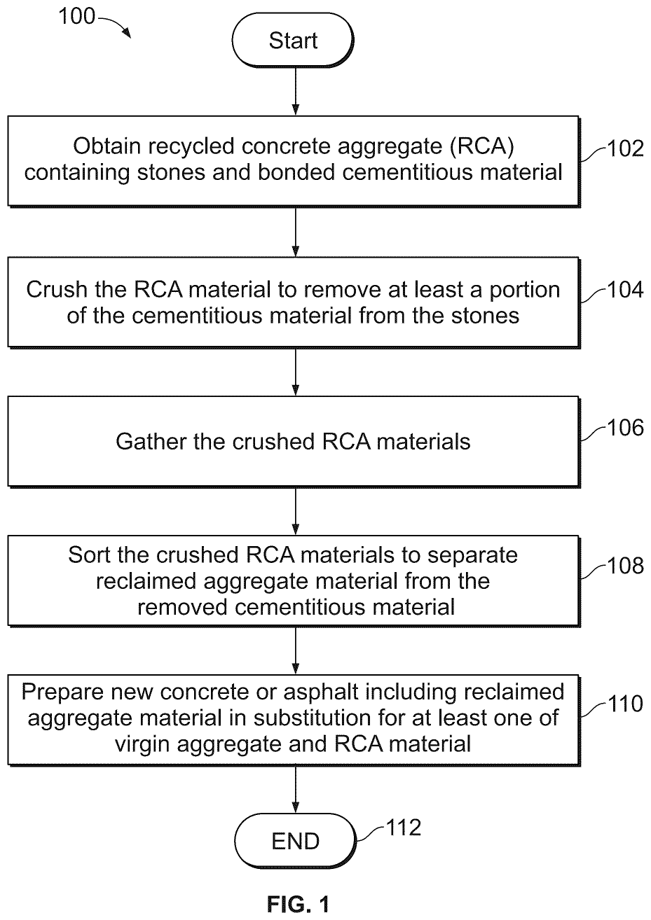

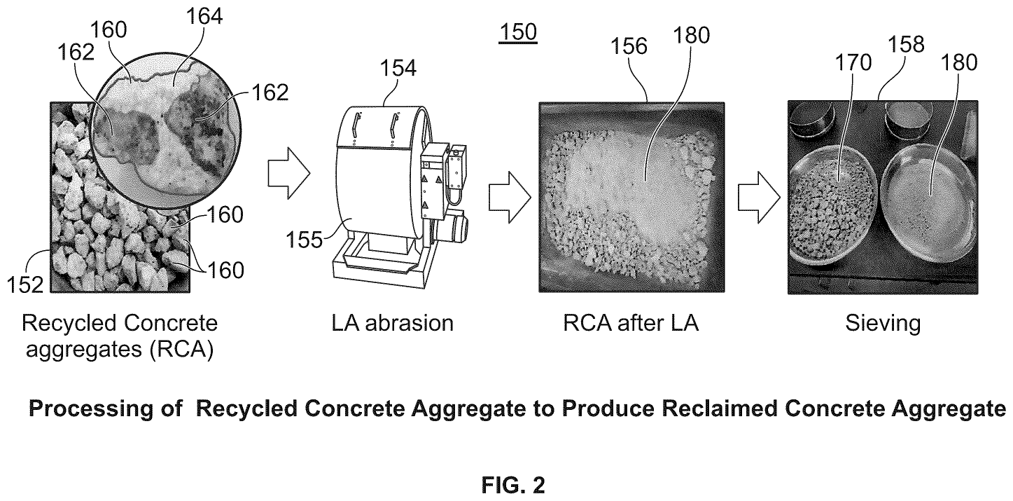

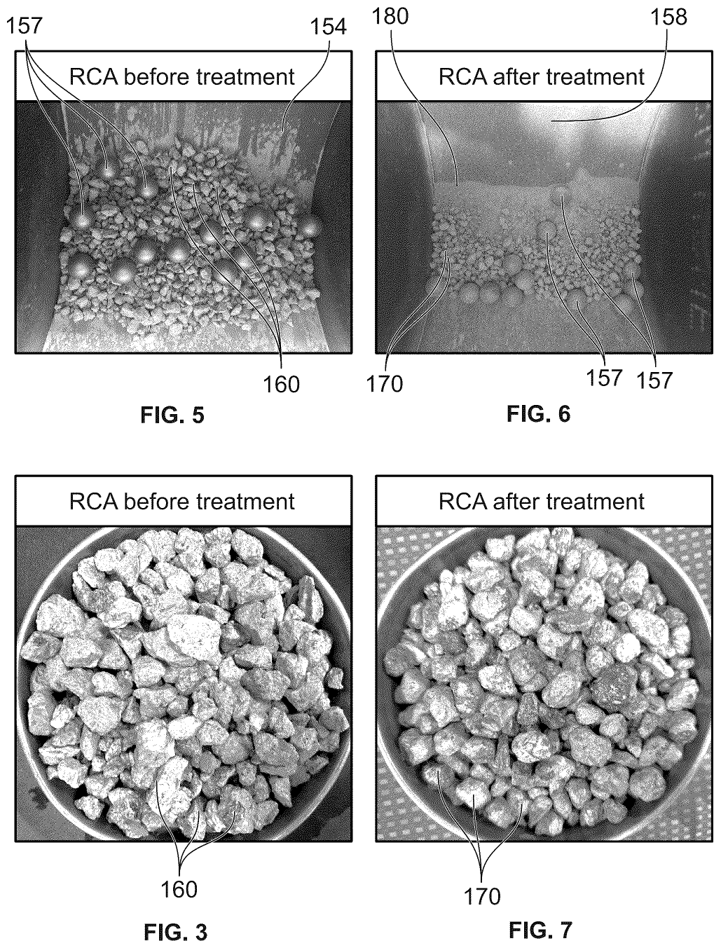

FIG. 1 is a flow diagram illustrating an exemplary method for recycling concrete waste to produce RCA, reclaimed concrete aggregate, and structures formed of new concrete comprising reclaimed concrete aggregate, in accordance with an exemplary embodiment of the present invention. As shown in FIG. 1, the exemplary flow diagram 100 starts with obtaining conventional recycled concrete aggregate (RCA) materials, which may involve obtaining concrete waste materials from demolished concrete aggregates, etc., and crushing them in a conventional manner to obtain conventional RCA), as shown at 102. Exemplary conventional RCA is shown in image 152 of the process diagram 150 of FIG. 2 and in FIG. 3. As will be noted in FIGS. 2 and 3, the conventional RCA is derived by crushing cured concrete material, and each particle/chunk 160 of RCA generally includes cement and/or mortar material (collectively referred to as cementitious material) 162 adhered/bonded to what was virgin aggregate (e.g., stone) 164 material as a result of the formation of the cured concrete in a conventional concrete manufacturing process, as best shown in FIG. 2.

Referring again to FIG. 1, the exemplary method next involves crushing (e.g., impacting/grinding/abrading) the conventional RCA material to remove at least a portion of the cemented material from the aggregate material (e.g., stones), as shown at 104. By way of example, the crushing may involve one or more crushing steps, and each crushing step may involve tumbling, abrasion, grinding and/or impact-based steps. By way of example, a crushing step involving tumbling of conventional RCA materials in a drum along with heavy impactors 157, such as heavy steel balls hard enough to crush the RCA material during tumbling in the drum, may be suitable for this purpose. This may be performed in a manner somewhat similar to use of a conventional Los Angeles (LA) testing process in an LA abrasion machine.

The amount of cemented material removed from the aggregate material can be controlled by varying the impact treatment step. For example, varying the duration of tumbling, or the intensiveness of tumbling, e.g., by using different impactors, drum rotation or impact speed, etc., can result in relatively more or relatively less cemented material removal from the aggregate. Generally, longer impact treatment steps will result in relatively more cemented material removal. The degree of cemented material removed may be varied according to the intended end use application for the reclaimed concrete aggregate material, as will be appreciated by those skilled in the art.

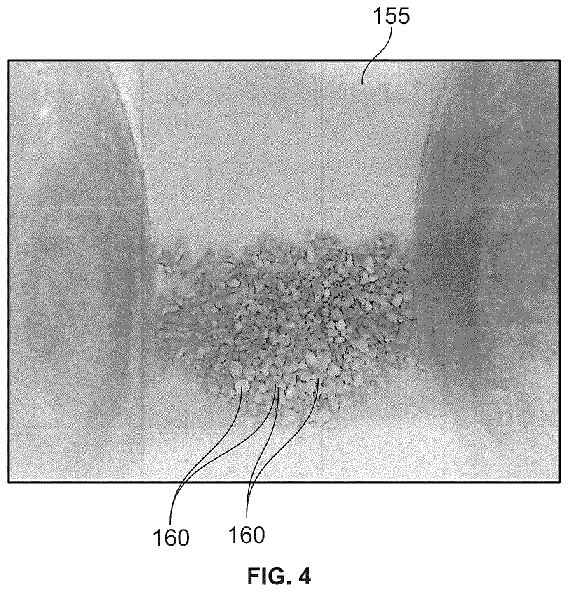

An exemplary LA abrasion machine 154 (drum-based tumbling machine) having a drum 155 is shown in FIG. 2. FIG. 4 shows the obtained RCA material 152/160 of FIG. 3 in the drum 155 of the LA abrasion machine 154. FIG. 5 shows the obtained RCA material of FIG. 3 and impactors 157 in the drum 155 of the LA abrasion machine 154. In this state, the RCA material 160 is ready for crushing impact treatment by tumbling in the LA abrasion machine 154.

The method next involves gathering the crushed RCA materials, as shown at 106 of FIG. 1. FIG. 6 shows the crushed RCA materials resulting from crushing of the RCA particles/chunks 160 after the crushing impact treatment, along with the impactors (heavy steel balls) 159, in the drum 155 of the LA abrasion machine 154. The gathering step involve removing the impactors 157 from the crushed RCA materials. The crushed RCA materials, after removal of the impactors 157, is shown in image 156 of the process diagram of FIG. 2.

Notably, the crushed RCA materials include a combination of reclaimed concrete aggregate material 170 resulting from the impact treatment process, and smaller cementitious particles 180 (e.g., dust/fine granules that may be roughly from about 0.1 microns to about a few millimeters in size) that have been removed/separated from the stones/aggregate of the RCA particles chunks 160 by the impact treatment process, as will be appreciated from image 156 of FIG. 2 and FIG. 6.

Next, the exemplary method involves sorting the crushed RCA material to separate the reclaimed aggregate material 170 from the smaller cementitious particles 180, as shown at 108. By way of example, such sorting may involve sieving the crushed RCA material to obtain the desired reclaimed concrete aggregate material 170 (likely having a particle size range of about 1 millimeter to about 50 millimeters, or otherwise consistent with conventional virgin natural concrete aggregate particle sizes), with the sieve structure to pass smaller particles sizes characteristic of crushed cementitious material (e.g., having particle size in a range of about 1 nanometer to about several millimeters).

FIG. 7 and image 158 of FIG. 2 show the reclaimed concrete aggregate material 170 after sorting/sieving to separate the reclaimed concrete aggregate material 170 from the particle material 180 removed by the crushing impact treatment. The reclaimed concrete aggregate material generally consists of the same aggregate material (e.g., stones, same as the original aggregate material in the concrete used to form the conventional RCA), and a relatively small amount of adhered/bonded cementitious material. Notably, the reclaimed concrete aggregate material 170 contains less adhered/bonded cemented material than the conventional RCA material used as starting materials for the impact treatment process.

Then, in accordance with this exemplary embodiment of the present invention, the method includes preparing new concrete (or asphalt) including the reclaimed aggregate material 170 as an alternative/in substitution for conventional RCA or virgin aggregate material (e.g., stones), as shown at 110, and the method ends, as shown at 112.

Notably, this step may involve producing a cast concrete structure, and particularly, a structural element of a building or other structure that is intended to carry a structural load typical of building and structure construction. Notably concrete include the reclaimed (treated) RCA in accordance with the present invention has improved compressive strength relative to comparable concrete including conventional untreated RCA.

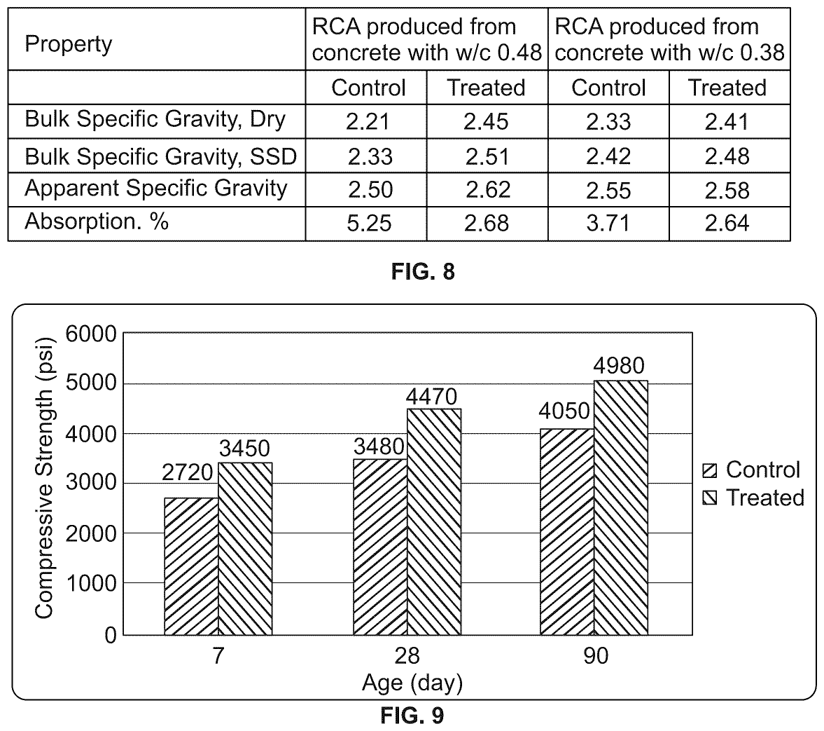

FIG. 8 shows a table showing bulk specific gravity (both dry and saturated surface dry), apparent specific gravity, and absorption of a control (conventional untreated RCA) and reclaimed concrete aggregate (conventional RCA after impact treatment in accordance with the present invention), for RCA generated by crushing concrete mixes prepared with water-cement ratios of 0.48 and 0.38, respectively, exhibiting different compressive strengths. The compressive strength of the two original concrete mixes are as follows: compressive strength for w/c of 0.48-5210 psi at 190 day; and compressive strength for w/c of 0.38-9810 psi at 190 day. Both treated recycled concrete aggregates (water-cement ratios 0.48 and 0.38) show an increase in bulk specific gravity and apparent specific gravity (desired for improving RCA quality) and a reduction in absorption (desired for improving RCA quality).

FIG. 9 is a graph comparing compressive strengths of exemplary concrete specimens including conventional RCA (control) and reclaimed concrete aggregate ((conventional RCA after impact treatment in accordance with the present invention), after 7, 28 and 90 days of curing, respectively, showing that impact treatment of the RCA has resulted in improved concrete strength consistent with the present invention.

Creating reclaimed concrete aggregate in this manner provides for production of new concrete suitable for structural use that is derived from RCA with significantly less carbon dioxide production as compared with processes for heating or otherwise treating conventional RCA material in a conventional manner. Further, creating new concrete including reclaimed concrete aggregate produced by impact treatment in accordance with the present invention make the concrete suitable for use in structural/load bearing applications in structure and building construction applications.

In accordance with another exemplary application, reclaimed concrete aggregate produce by the impact treatment process described herein may also be used as aggregate, as an alternative or substitution for virgin aggregate or RCA, in the production of asphalt.

New concrete mixes (classes from normal concrete to ultra-high-performance concrete, and including concrete mixes suitable for use in 3D-printing/additive construction processes, shotcrete (spray) processes, or any other processes involving manual, mechanized or robotic construction) in accordance with the present invention may be made by preparing concrete including reclaimed concrete aggregate as described herein.

New asphalt in accordance with the present invention may be made by preparing asphalt comprising a mixture of bitumen and reclaimed concrete aggregated prepared as described herein, in at least partial substitution for virgin aggregate or RCA material, in an asphalt mix.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A method for producing reclaimed concrete aggregate for use as an alternative to virgin aggregate, the method comprising:
obtaining recycled concrete aggregate waste material comprised of aggregate particles to which cementitious material is bonded;
crushing the recycled concrete aggregate waste material to remove at least a portion of the bonded cementitious material from the aggregate particles;
gathering the crushed recycled concrete aggregate waste material, the crushed recycled concrete aggregate waste material comprising reclaimed concrete aggregate particles and cementitious waste particles derived from said recycled concrete aggregate waste material; and
sorting the crushed recycled concrete aggregate waste material to obtain reclaimed concrete aggregate by separating the reclaimed concrete aggregate particles from the cementitious waste particles, said reclaimed concrete aggregate particles having less bonded cementitious material than said aggregate particles of said recycled concrete aggregate waste material.

2. The method of claim 1, further comprising treating the reclaimed concrete aggregate by adding at least one of a filler, a gradation and a solution to the reclaimed concrete aggregate.

3. The method of claim 1, wherein said obtaining recycled concrete aggregate waste material comprises at least one of obtaining recycled concrete aggregate (RCA) material, obtaining concrete waste material and crushing it to create RCA material, and obtaining demolished concrete aggregate material and crushing it to create RCA material.

4. The method of claim 1, wherein said crushing the recycled concrete aggregate waste material comprises tumbling the recycled concrete aggregate waste material and impactors in a rotating drum.

5. The method of claim 1, wherein said crushing the recycled concrete aggregate waste material comprises crushing to provide particles having a size falling in a range of about 1 millimeter to about 50 millimeters.

6. The method of claim 1, wherein said sorting the crushed recycled concrete aggregate waste material comprises separating reclaimed concrete aggregate particles having particle sizes falling in a range of about 1 millimeter to about 1 nanometer from smaller cementitious waste particles.

7. The method of claim 1, wherein said sorting the crushed recycled concrete aggregate waste materials comprises sieving to obtain reclaimed concrete aggregate particles fines having at least one of a desired particle size, an average particle size, and a particle size distribution.

8. A method for producing an aggregate mix material comprising reclaimed concrete aggregate particles in substitution for virgin aggregate particles, the method comprising:
obtaining recycled concrete aggregate waste material comprised of aggregate particles to which cementitious material is bonded;
crushing the recycled concrete aggregate waste material to remove at least a portion of the bonded cementitious material from the aggregate particles;
gathering the crushed recycled concrete aggregate waste material, the crushed recycled concrete aggregate waste material comprising reclaimed concrete aggregate particles and cementitious waste particles derived from said recycled concrete aggregate waste material; and
sorting the crushed recycled concrete aggregate waste material to obtain reclaimed concrete aggregate by separating the reclaimed concrete aggregate particles from the cementitious waste particles, said reclaimed concrete aggregate particles having less bonded cementitious material than said aggregate particles of said recycled concrete aggregate waste material; and
preparing at least one of a concrete mix and an asphalt mix comprising said reclaimed concrete aggregate particles.

9. The method of claim 8, further comprising treating the reclaimed concrete aggregate by adding at least one of a washing, a filler, a gradation and a solution to the reclaimed concrete aggregate.

10. The method of claim 8, wherein said obtaining recycled concrete aggregate waste material comprises at least one of obtaining recycled concrete aggregate (RCA) material, obtaining concrete waste material and crushing it to create RCA material, and obtaining demolished concrete aggregate material and crushing it to create RCA material.

11. The method of claim 8, wherein said crushing the recycled concrete aggregate waste material comprises tumbling the recycled concrete aggregate waste material and impactors in a rotating drum.

12. The method of claim 8, wherein said crushing the recycled concrete aggregate waste material comprises crushing to provide particles having a size falling in a range of about 1 millimeter to about 50 millimeters.

13. The method of claim 8, wherein said sorting the crushed recycled concrete aggregate waste material comprises separating reclaimed concrete aggregate particles having particle sizes falling in a range of about 1 millimeter to about 1 nanometer from smaller cementitious waste particles

14. The method of claim 8, wherein said sorting the crushed recycled concrete aggregate waste materials comprises sieving to obtain reclaimed concrete aggregate particles fines having at least one of a desired particle size, an average particle size, and a particle size distribution.

15. The method of claim 8, further comprising:
curing said aggregate mix material in a form to manufacture a load-bearing member structural member of at least one of a building and a structure.

16. An aggregate mix material comprising:
sand;
cement;
water; and
aggregate material, at least about 1% to about 100% of said aggregate material comprising reclaimed concrete aggregate particles derived by crushing concrete waste material.

17. The aggregate mix material of claim 16, wherein said reclaimed concrete aggregate particles comprise natural stone aggregate material to which less paste material is bonded than in a recycled concrete aggregate material.

18. The aggregate mix material of claim 16, wherein said aggregate mix material is a concrete material.

19. The aggregate mix material of claim 16, wherein said aggregate mix material is an asphalt mix material further comprising bitumen material.
